(19) United States
(12) Patent Application Publication
(10) Pub. No.: US 2024/0185205 A1
(43) Pub. Date: Jun. 6, 2024

(54) SYSTEMS, DEVICES, AND RELATED METHODS FOR UPSELL OPTIONS AND DELIVERY MANAGEMENT FOR SELF-CHECKOUT SYSTEMS

(71) Applicant: Datalogic USA, Inc., Eugene, OR (US)

(72) Inventor: Steven W. Gutke, Eugene, OR (US)

(21) Appl. No.: 18/061,387

(22) Filed: Dec. 2, 2022

(51) Int. Cl. G06Q 20/20; G06Q 10/083

(52) U.S. Cl. CPC G06Q 20/208; G06Q 10/083

(57) ABSTRACT

The disclosure relates to a data reading system operable for obtaining and decoding data from items processed by a customer in a retail transaction, where the data reading system analyzes the purchased items in the transaction and evaluates opportunities for presenting add-on items to the customer during the transaction based on the purchased items. The data reading system may further analyze purchase history information for the customer along with real-time customer input to determine additional opportunities for add-on items. In addition, the data reading system is designed to present the add-on items to the customer along with facilitating in-store delivery and home delivery for the customer.

### BACKGROUND

The present disclosure relates generally to data reading systems in a retail setting, and more particularly, to point-of-sale systems designed to present opportunities for up-selling or cross-selling items to a consumer during a retail transaction.

Data reading systems in general are used in a variety of settings for reading optical codes, acquiring data, and/or capturing images from items. In a retail environment, data reading devices are well known for reading UPC and other types of optical codes (e.g., barcodes) on grocery items or packages to identify the item and add the item to the customer's transaction list for purchasing during a checkout process. In a conventional self-checkout system, the customer can scan, weigh, and pay for items without the need for assistance by a store clerk or any other personnel. While a self-checkout system streamlines the transaction for the customer and creates a faster overall checkout process, the elimination of a store clerk from the process reduces the opportunity to engage the customer and potentially increase the sale of items that may be of interest to the customer. For example, during a checkout transaction, the store clerk may ask the customer whether they would like to purchase a complementary item, such as batteries, to power the electronic device purchased by the customer.

Accordingly, the inventor has identified a need for a self-checkout system designed to improve the self-checkout process and the overall customer experience, where the self-checkout system is designed to identify and present up-selling and cross-selling opportunities to the customer. In addition, the inventor has identified a need for such a system capable of providing in-store or at-home options to the customer for delivering the add-on items. Additional aspects and advantages of such systems will be apparent from the following detailed description of example embodiments, which proceed with reference to the accompanying drawings.

Understanding that the drawings depict only certain embodiments and are not, therefore, to be considered limiting in nature, these embodiments will be described and explained with additional specificity and detail with reference to the drawings.

### BRIEF DESCRIPTION OF THE DRAWINGS

FIG. 1 illustrates a data reading system operable for scanning items and processing a purchase transaction in accordance with one embodiment.

FIG. 2 is a simplified block diagram of the data reading system of FIG. 1 in accordance with one embodiment.

FIG. 3 is a flowchart illustrating a process for identifying additional sales opportunities during a transaction at the self-checkout system of FIG. 1.

FIG. 4 is a diagram illustrating a delivery management system for in-store product delivery based on a customer request in accordance with one embodiment.

### DETAILED DESCRIPTION OF DISCLOSED EMBODIMENTS

With reference to the drawings, this section describes specific embodiments relating to a data reading system and its detailed construction and operation. The embodiments described herein are set forth by way of illustration only and not limitation. The described features, structures, characteristics, and methods of operation may be combined in any suitable manner in one or more embodiments. In view of the disclosure herein, those skilled in the art will recognize that the various embodiments can be practiced without one or more of the specific details or with other methods, components, materials, or the like. In other instances, well-known structures, materials, or methods of operation are not shown or not described in detail to avoid obscuring more pertinent aspects of the embodiments.

With collective reference to the figures, the following disclosure relates to a data reading system, such as a self-checkout system or other suitable point-of-sale system, used in a retail setting to complete a customer transaction for the purchase of various goods offered in a retail facility. The data reading system may include any suitable components for capturing data from an item and any suitable reading engine configuration for decoding the captured data to complete the retail transaction. As further described in detail below, the data reading system is designed to analyze the customer transaction list (also referred to as a “transaction log”) for items being purchased and may also evaluate a customer's purchase history information along with receiving and processing real-time customer input to assess opportunities for up-selling or cross-selling items to the customer at the point-of-sale. These add-on items may be presented to the customer at the point-of-sale via the data reading system and allow the customer to select any one or more of the add-on items as desired. At the point-of-sale, the customer may select to receive the add-on items at the store prior to departing or may arrange for home delivery if desired, such as when the add-on item is of interest but not currently in stock or if the add-on item is large or heavy. Additional details of these and other embodiments of the data reading system are further discussed below with reference to the accompanying figures.

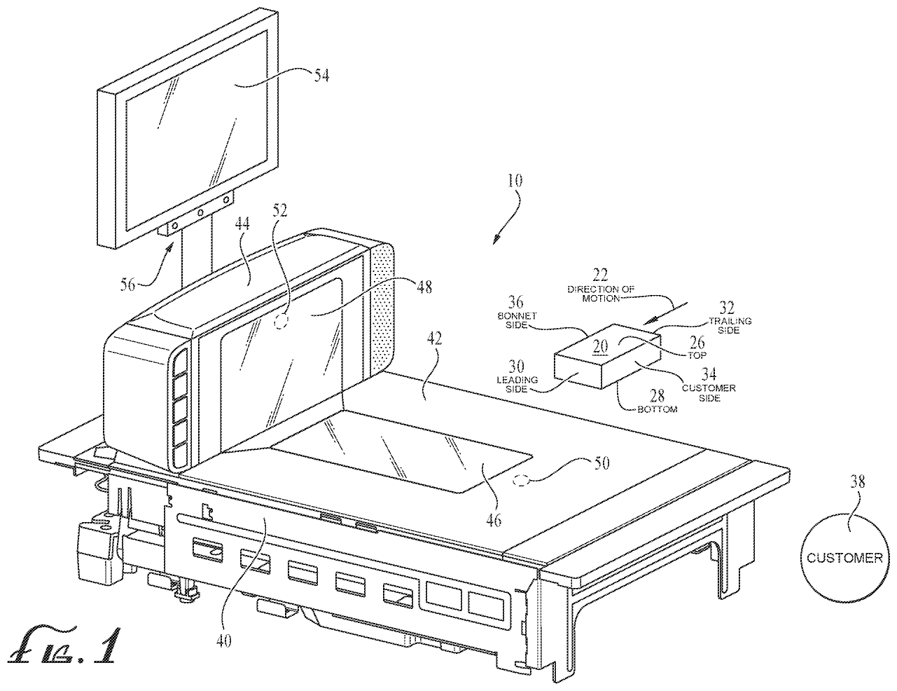

FIG. 1 illustrates an example embodiment of a data reading system 10 in accordance with one embodiment. The following section briefly describes general components of the data reading system 10 and provides an example operation of the data reading system 10 when used in a retail establishment to process a transaction. With reference to FIG. 1, the data reading system 10 may be a self-checkout system designed to be used by a customer 38 to scan, weigh (as needed), and pay for items 20 without the need for assistance by a store clerk or other personnel. As illustrated in FIG. 1, the data reading system 10 is operable to obtain information (e.g., optical codes, images, etc.) from an example six-sided item 20 (e.g., a grocery item) that is passed along a direction of motion 22 through a read region of the data reading system 10. For general purposes of discussion, the item 20 is represented in the figures as a six-sided, box-shaped package having a top surface 26, a bottom surface 28, a leading side 30, a trailing side 32, a customer side 34, and a bonnet side 36. While the item 20 is illustrated and described as a box-shaped package for convenience, it should be understood that the item 20 may encompass other shapes, including, for example, round fruits or vegetables, cylindrical cans, irregularly shaped packages, such as a bag of potatoes, potato chips, or the like.

The data reading system 10 may be a two-plane or bioptic reader having a lower base section 40 supporting a platter 42, and a bonnet or raised upper section 44 extending from and protruding upwardly from the platter 42 (and the lower base section 40). The data reading system 10 includes one or more data readers 50 housed within lower base section 40 underneath the platter 42, and the bonnet 44 may further include one or more data readers 52 housed therein. The data readers 50, 52 are arranged within the platter 42 and bonnet 44, respectively, to project their fields-of-view through the respective windows 46, 48 to capture and decode an optical code on the item 20 as it moves through the combined read region of the data reading system 10. In some embodiments, the data reading system 10 may incorporate any suitable optical components (not shown) within the lower base section 40 and bonnet 44 to ensure the respective fields-of-view of the data readers 50, 52 are oriented as needed to capture data from the item 20. In other embodiments, the data reading system may be a single plane reader without a bonnet or may have other suitable configurations. In some embodiments, a data reader may be incorporated within a smart shopping cart system that includes data readers and a display for scanning items as they are placed within the shopping cart. Transactions (including the offering and inclusion of any add-on items) may be completed via the display and related user interface of such a smart shopping cart system or via a connected device.

For purposes of this disclosure, reference to a “data reader” is used in an expansive sense to describe any suitable device (or combination of devices) capable of obtaining and decoding coded information from an item 20. In some embodiments, a data reader may include a camera or other suitable imaging system, a processor, a decoding unit, and a controller for communicating data to other data readers or external systems for processing. In other embodiments, the data reader may include a subset of these components within a common housing and other components may be external to the data reader itself. For example, in one embodiment, the data readers may each include an imager designed to obtain images of the item 20 and communicate those images to the decoding unit (which may be part of the processor) in an external database for decoding the coded information captured in the images and identify the item 20.

The data readers may include any suitable decoding algorithms to decode coded information from the item 20 that may be contained within one-dimensional codes, two-dimensional codes, stacked codes, or other code configurations. In this disclosure, the data readers 50, 52 may be referenced as including imagers or imaging systems, but it should be understood that the reference is meant to provide an example configuration for the data readers. Other data reader configurations may be used without departing from the principles of the disclosed subject matter. Examples of various data reader configurations include U.S. Pat. No. 8,430,318, issued Apr. 30, 2013, and entitled “SYSTEM AND METHOD FOR DATA READING WITH LOW PROFILE ARRANGEMENT,” U.S. Pat. No. 9,004,359, issued Apr. 14, 2015, entitled “OPTICAL SCANNER WITH TOP DOWN READER,” U.S. Pat. No. 9,305,198, issued Apr. 5, 2016, entitled “IMAGING READER WITH IMPROVED ILLUMINATION,” U.S. Pat. No. 10,049,247, issued Aug. 14, 2018, entitled “OPTIMIZATION OF IMAGE FRAME MANAGEMENT IN A SWEEP-STYLE OPTICAL CODE DATA READER,” U.S. Pat. No. 10,248,896, issued Apr. 2, 2019, and entitled “DISTRIBUTED CAMERA MODULES SERIALLY COUPLED TO COMMON PREPROCESSING RESOURCES FACILITATING CONFIGURABLE OPTICAL CODE READER PLATFORM FOR APPLICATION-SPECIFIC SCALABILITY,” and U.S. Patent Application Publication No. 2020/0125812, filed Dec. 2, 2019, and entitled “DATA COLLECTION SYSTEMS AND METHODS TO CAPTURE IMAGES OF AND DECODE INFORMATION FROM MACHINE-READABLE SYMBOLS,” and U.S. Patent Application Ser. No. 63/293,563, filed Dec. 23, 2021, and entitled “FIXED RETAIL SCANNER WITH MULTI-PORT NETWORK SWITCH AND RELATED METHODS, the disclosure of each of which is incorporated by reference herein in its entirety.

With reference to FIG. 1, the following provides an example operation of the data reading system 10 in accordance with one embodiment. During a transaction, the item 20 is moved along the direction of motion 22 across the platter 42 above the scan window 46 and in front of the scan window 48. As the item 20 is moved across the scan windows 46, 48, the data readers 50, 52 cooperate to obtain image data for all sides of the item 20 to find and decode the optical code. For example, if the optical code (or other target data) is present on the bonnet side surface 36 of the item 20, the data reader 52 reading through the window 48 of the bonnet 44 will capture the optical code in an image of the side surface 36 for decoding. Similarly, if the optical code is on the bottom surface 28 of the item 20, then the data reader 50 reading through the window 46 may capture the optical code in an image for decoding. Likewise, if the optical code is on any of the remaining surfaces of the item 20, one or both data readers 50, 52 (either individually or in combination) may capture image views bearing the optical code on the item 20 for decoding. If the optical code is positively captured and decoded, the data reading system 10 may emit a beeping (or other) sound indicating that the optical code was properly read, indicating to the customer 38 that the next item 20 may be processed. Alternatively, the data reading system 10 may emit a different beeping (or other) sound indicating that the optical code was not properly read and may also emit a message requesting that the customer 38 reprocess the item 20.

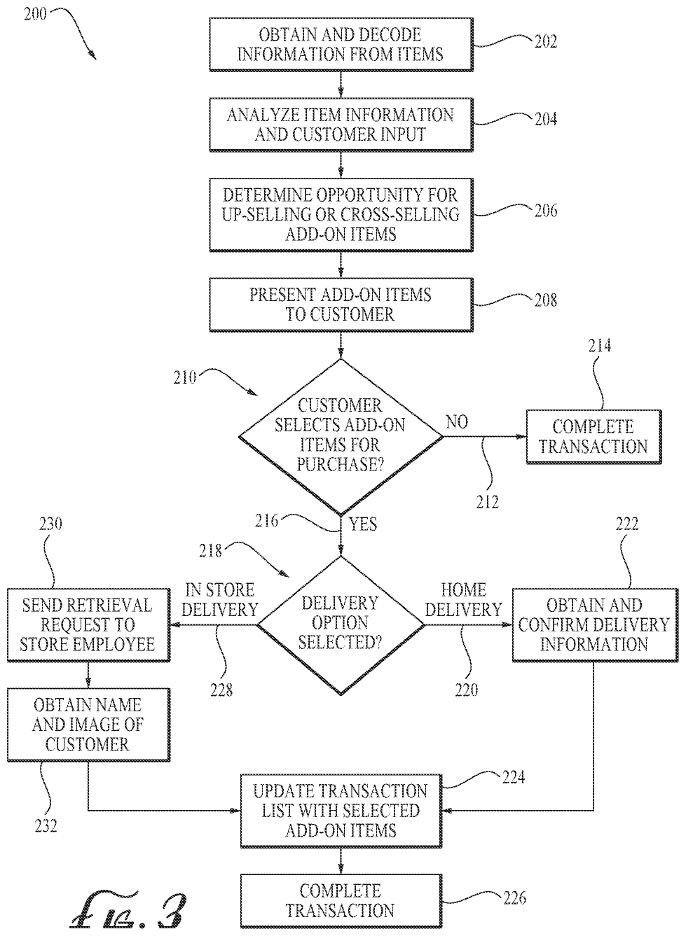

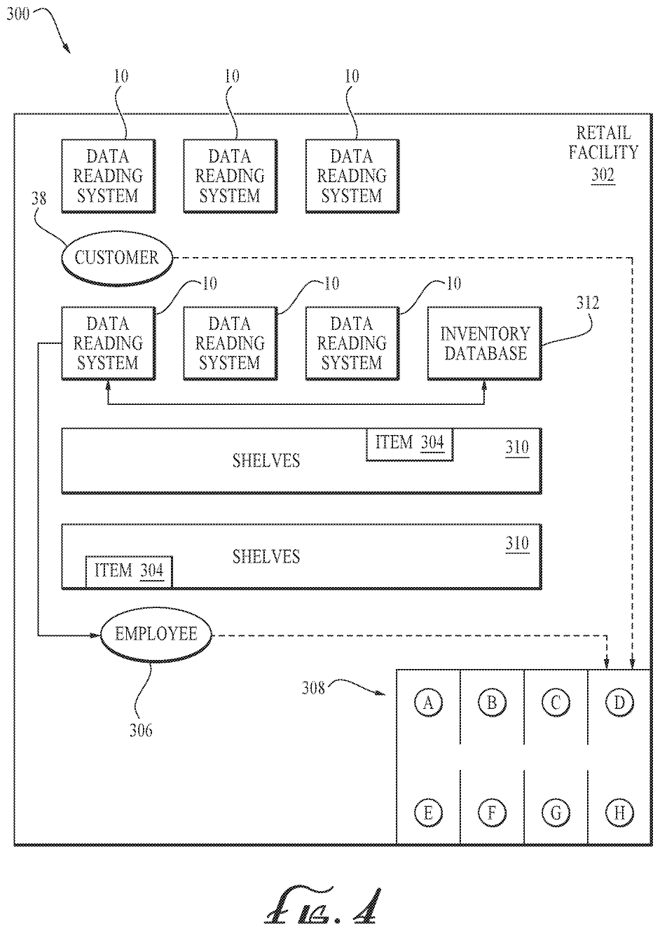

As illustrated in FIG. 1, the data reading system 10 includes a display 54 operable to display information, such as a running transaction list of the items 20 purchased, images, selectable icons, text, or other suitable information to facilitate the transaction. The data reading system 10 further includes a camera 56 operable for obtaining images of the customer 38 as further described in detail below with reference to FIGS. 3-4 and/or images of the items 20 to aid in the transaction as needed. In some embodiments, the display 54 may show an image of a purchased item captured by the camera 56, (and/or captured by data readers 50, 52 or other cameras internal to the data reader housing), a list of purchase items and running costs, options for identifying items by name or image, item weight, or other suitable transaction information associated with the items 20. In some embodiments, the display 54 may be a touch screen that allows the customer 38 to interact directly with the screen (or via a stylus or other suitable instrument) to enter information and respond to prompts to allow the customer 38 to manage the transaction. The touch screen may be any of several suitable display types, such as an integrated liquid crystal (LCD) display, an organic light-emitting diode (OLED) display, or other display with suitable touch screen capabilities for detecting the customer's touch via a finger, stylus, or other suitable input device.

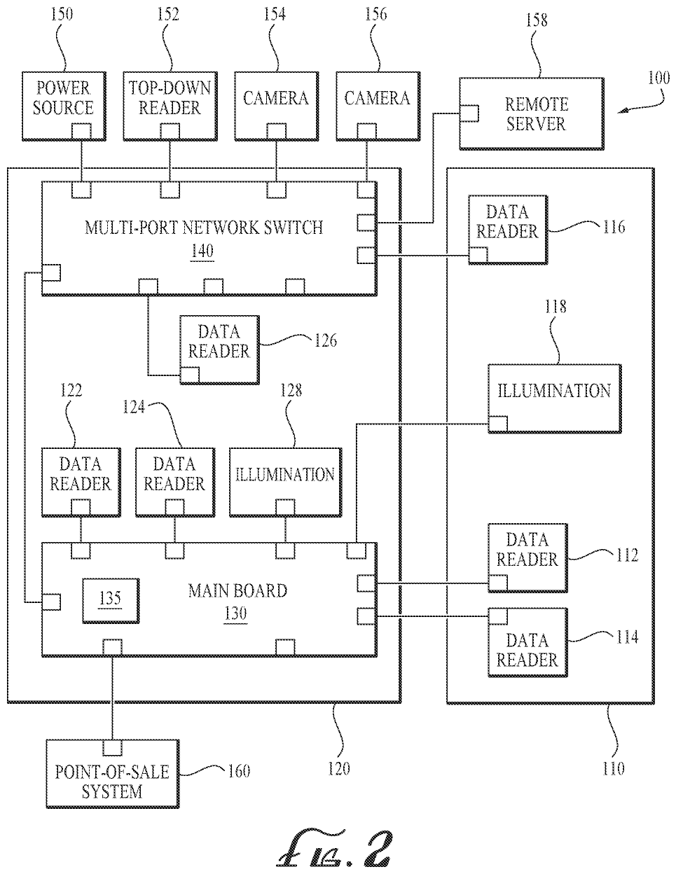

FIG. 2 is a simplified block diagram of a data reading system 100 according to an embodiment of the disclosure. As illustrated in FIG. 2, the data reading system 100 be operably coupled with one or more of a power source 150, a top-down reader (TDR) 152, peripheral cameras 154, 156, a remote server 158, or a point of sale (POS) system 160. Additional details of the data reading system 100 are described below.

With reference to FIG. 2, the data reading system 100 may be a bi-optic fixed retail scanner having a vertical housing 110 and a horizontal housing 120 (in a similar fashion as the data reading system 10 of FIG. 1) in some embodiments. The data reading system 100 may be installed in a retail environment (e.g., grocery store), which typically is disposed within a counter or other support structure of an assisted checkout lane or a self-checkout lane. The vertical housing 110 may include a structure that provides for one or more data reader fields of view (through a vertical window) within a generally vertical plane across the read-zone of the data reading system 100. The vertical housing 110 provides an enclosure for one or more data readers 112, 114, 116, active illumination assemblies 118 (e.g., LED assemblies), and other optical elements (e.g., lenses, mirrors, etc.) and electrical elements (e.g., cables, circuit boards, etc.) therein. Similarly, the horizontal housing 120 may include a structure that provides for one or more data reader fields of view (through a horizontal window) within a generally vertical plane across the read-zone of the data reading system 100. The horizontal housing 120 provides an enclosure for one or more data readers 122, 124, 126, active illumination elements 128 (e.g., LED assemblies), and other optical elements (e.g., lenses, mirrors, etc.) and electrical elements (e.g., cables, circuit boards, etc.) therein. Thus, the vertical housing 110 and the horizontal housing 120 may be generally orthogonal to each other. Depending on the arrangement and orientation of the different opto-electrical elements, certain elements related to providing a horizontal field of view may be physically located within the vertical structure and vice versa.

In one embodiment, the data reading system 100 may include one or more different types of data readers, such as monochrome imagers and/or color imagers. For example, data readers 112, 114 in vertical housing 110 may be monochrome imagers configured to capture monochrome images through the vertical window of the data reading system 100. Likewise, data readers 122, 124 in horizontal housing 120 may be monochrome imagers configured to capture monochrome images through the horizontal window of the data reading system 100. Data reader 116 in vertical housing 110 may be a color camera module configured to capture color images through the vertical window of the data reading system 100. Likewise, data reader 126 in horizontal housing 120 may be a color camera module configured to capture color images through the horizontal window of the data reading system 100. In such embodiments, monochrome images may be analyzed (e.g., by a decoder) to decode one or more indicia (e.g., 1D barcodes, 2D barcodes, optical character recognition, digital watermarks, etc.). and color images may be analyzed (e.g., by an image processor) where color information may be particularly advantageous, such as produce recognition, item recognition or verification, and security analysis. Such analysis may be performed by local and/or remote processors that may contain an artificial intelligence (AI) engine or otherwise configured to perform other machine learning techniques.

The data reading system 100 may further include a main board 130 and a multi-port network switch 140. As shown herein, the main board 130 and the multi-port network switch 140 may be disposed within the horizontal housing 120 in one embodiment. Bi-optic readers tend to have a larger horizontal housing (as compared to the vertical housing), which provides support for the device within a cavity in a counter and provides space to support a scale (not shown) used to weigh produce or other items sold by weight or otherwise perform weighing of items when placed on the horizontal surface (often called a “weigh platter”). It is contemplated that other embodiments may instead include the main board 130 and/or the multi-port network switch 140 within the vertical housing 110. In an embodiment where one of the multi-port network switch 140 or the main board 130 is disposed within the vertical housing 110 and the other is disposed within the horizontal housing 120, the two boards may be oriented orthogonal to each other similar to the orientation of the windows. The ports may be at least somewhat aligned in the orthogonal direction to accommodate easy connection of network cables therebetween.

The main board 130 may be operably coupled with the data readers 112, 114 and the data readers 122, 124, such as via a communication interface (e.g., a MIPI interface) or other suitable interface. The main board 130 may have decoding software embedded therein such that one or more on-board processors 135 may receive monochrome images to perform decoding on the optical indicia and provide the decoding result to a point of sale (POS) system 160 operably coupled thereto to complete a transaction. The one or more on-board processors 135 may also be configured to provide control (e.g., coordination or synchronization) of the various components of the system including camera exposure and timing of active illumination assemblies 118, 128 of the system. Although a single block is shown representing one or more on-board processors 135, it is contemplated that some embodiments may include multiple processing components (e.g., microprocessors, microcontrollers, FPGAs, etc.) configured to perform different tasks, alone or in combination, including object detection, system control, barcode decoding, optical character recognition, artificial intelligence, machine learning analysis, or other similar processing techniques for analyzing the images for product identification or verification or other desired events.

The multi-port network switch 140 may be operably coupled to data reader 116 and data reader 126 located within the data reading system 100. The multi-port network switch 140 may also be operably coupled with main board 130 located within the data reading system 100. Multi-port network switch 140 may also be operably coupled to the power source 150 as well as peripheral devices such as the TDR 152, peripheral cameras 154, 156, and/or the remote server 158. The number and types of peripheral devices may depend on a desired application within a retail environment. The TDR 152 may be configured as a stand connected to the data reading system 100 that typically provides a generally close overhead (angled) view of the read-zone to provide a top view of a product whereas internal data readers 112, 114, 116, 122, 124, 126 may be better suited for capturing images of the bottom and/or sides of the object within the read-zone. Peripheral cameras 154, 156 may be located remotely from the data reading system 100 such as being mounted on a ceiling or wall of the retail environment to provide additional views of the read-zone or checkout area. Such views may be useful for security analysis of the checkout area such as product verification, object flow, human movements, etc. Such analysis may be performed by a remote service or other local devices (e.g., located on or otherwise coupled to the main board 130 or ethernet switch 140). Other peripheral devices may be located near the data reading system 100, such as a peripheral presentation scanner resting or mounted to a nearby surface, and/or a handheld scanner that also may be used for manual capturing by the user (e.g., checkout assistant or self-checkout customer). Such devices may be coupled directly to the main board 130 in some embodiments or to the multi-port network switch 140 if so enabled. As shown, the POS 160 may be coupled directly to the main board 130. Such a connection may be via communication interfaces such as USB, RS-232, or other such interfaces. In some embodiments, the POS 160 may be coupled directly to the multi-port network switch 140 if so enabled (e.g., as an ethernet connected device).

The multi-port network switch 140 may be implemented on a separate board from the main board 130. The multi-port network switch 140 may include a plurality of ports to provide advanced network connectivity (e.g., Ethernet) between internal devices within the data reading system 100 and external devices from the data reading system 100. Thus, the multi-port network switch 140 may provide an Ethernet backbone for the elements within the data reading system 100 as well as for external devices coupled to the data reading system 100 for control and/or managing data flow or analysis. As an example, multi-port network switch 140 may be implemented with a KSZ9567 Ethernet switch or other EtherSynch® product family member available from Microchip Technology Inc of Chandler, Arizona or other similar products configured to provide network synchronization and communication with network-enabled devices. Embodiments of the disclosure may include any number of ports supported by the multi-port network switch to couple to both internal devices (e.g., main board, cameras, etc.) and external devices (e.g., peripheral cameras, TDR, illumination sources, remote servers, etc.) to provide a flexible platform to add additional features for connecting with the data reading system 100.

Although FIG. 2 shows one block for active illumination assemblies 118, 128 in each of the vertical and horizontal housings 110, 120, some embodiments may include multiple such assemblies in each of the horizontal and vertical housings 110, 120 in order to provide for different lighting options at different angles across the read-zone. For example, the vertical housing 110 may include two (or more) illumination assemblies therein at different locations and/or different colors for a desired illumination field from the vertical view. Likewise, the horizontal housing 120 may include two (or more) illumination assemblies therein at different locations and/or different colors for a desired illumination field from the horizontal view. As shown herein, the illumination assemblies 118, 128 may be coupled directly to the main board 130. However, in some embodiments, additional components may be coupled within the path from the main board 130 such as a control panel or other such device. In yet other embodiments, the illumination assemblies 118, 128 may be coupled to the multi-port network switch 140 which may route triggering controls from the main board 130. TDR 152 and one or more of the peripheral cameras 154, 156 may also include associated illumination assemblies. Synchronization of such illumination sources may be managed by the multi-port network switch 140 as controlled by the main board 130. In some embodiments, the multi-port network switch may employ or leverage IEEE1588 Precision Time Protocol to synchronize the illumination system with remote cameras, which may enable clock accuracy in sub-microsecond range.

In operation, images may be captured by the data readers 112, 114, 116, 122, 124, 126. Monochrome images may be captured by monochrome data readers 112, 114, 122, 124 and color images may be captured by color data readers 116, 126. The multi-port network switch 140 may be configured to coordinate (e.g., synchronize) timing of camera exposure and active illumination (e.g., white illumination) with the color data readers 116, 126 (as controlled by the controller on the main board 130) to occur in an offset manner with the timing of the camera exposure and active illumination (e.g., red illumination) with the monochrome data readers 112, 114, 122, 124.

Image data (e.g., streaming video, image frames, etc.) from the color data readers 116, 126 may be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the color images internally within the data reading system 100 by the one or more processors 135 supported by the main board 130. In some embodiments, barcode decoding may also be performed on the color images internally within the data reading system 100 by the one or more processors 135 supported by the main board 130. Image data from the color data readers 116, 126 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the color images externally to the data reading system 100 by external devices coupled through the multi-port network switch 140. Such color images or other data stream may be routed directly to the network connected external devices through the multi-port network switch 140 without first being received by the main board 130 (if at all).

Image data from the monochrome data readers 112, 114, 122, 124 may be provided to the main board 130 to the processing/analysis modules located internal to the data reading system 100 such as the one or more processors 135 supported by the main board 130. As such, barcode decoding may also be performed on the color images internally within the data reading system 100 by the one or more processors 135 supported by the main board 130. In some embodiments, image analysis (e.g., AI, machine learning, OCR, object recognition, item validation, produce recognition, analytics, etc.) may be performed on the monochrome images internally within the data reading system 100 by the one or more processors 135 supported by the main board 130. Image data from the monochrome data readers 112, 114, 122, 124 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on the monochrome images externally to the data reading system 100 by external devices coupled through the multi-port network switch 140. Such monochrome images or other data stream may be routed directly to the network connected external devices to the multi-port network switch 140 after first being received by the main board 130.

Image data (e.g., streaming video, image frames, etc.) from the TDR 152 or other external peripheral cameras 154, 156 may be routed through the multi-port network switch 140 to the processing/analysis modules located internal to the data reading system 100 such as the one or more processors 135 supported by the main board 130. As such, image analysis (e.g., AI, machine learning, OCR, object recognition, item validation, produce recognition, analytics, etc.) may be performed on the images (e.g., color and/or monochrome) internally within the data reading system 100 by the one or more processors 135 supported by the main board 130. In some embodiments, barcode decoding may also be performed on such images internally within the data reading system 100 by the one or more processors 135 supported by the main board 130. Image data from the TDR 152 or other external peripheral cameras 154, 156 may also be routed through the multi-port network switch 140 to external devices, such as remote server 158 or other similar devices including any network enabled POS systems. As such, image analysis (e.g., AI, machine learning, OCR, object recognition, item validation, produce recognition, analytics, etc.) may be performed on these images externally to the data reading system 100 by external devices coupled through the multi-port network switch 140. Such images or other data stream may be routed directly to the network connected external devices through the multi-port network switch 140 without first being received by the main board 130 (if at all).

As described in further detail below with reference to FIGS. 3-4, in addition to processing purchases from the customer 38, the data reading systems 10, 100 described with reference to FIGS. 1-2 are operable to identify opportunities for up-selling and cross-selling add-on items 304 (see FIG. 4) to the customer 38 and present those opportunities to the customer 38 at the point-of-sale for consideration and potential purchase. Additional details of these and other embodiments are described below with reference to FIGS. 3 and 4. For convenience and to avoid repetition, the discussion of the methods illustrated in FIGS. 3 and 4 proceeds with reference to the data reading system 10 of FIG. 1, but it should be understood that the same methods described with reference to FIGS. 3 and 4 apply equally to the data reading system 100 of FIG. 2.

FIG. 3 is a flowchart of a method 200 for identifying additional sales opportunities for add-on items 304 and presenting the information to the customer 38 during a transaction at the data reading system 10. With reference to FIG. 3, at step 202, the data reading system 10 obtains and decodes information from the items 20 as they are processed by the customer 38 via the data reading system 10 during the checkout transaction. As described previously, in some checkout processes, the customer 38 may present the barcode on the items 20 to the scan windows 46, 48 for reading by the data readers 50, 52, or the customer may input an item description into the data reading system 10 via the display 54 to identify and process the item 20, or the customer 38 may take other suitable action to ensure the information for each item 20 in the transaction is received and processed by the data reading system 10.

Once the item information has been obtained by the data reading system 10 for all items 20, at step 204, the data reading system 10 analyzes (via a processor or other suitable module) the item information and receives and processes any additional information input directly by the customer 38 during the transaction. For example, in some embodiments, the data reading system 10 may prompt the customer 38 to enter loyalty account information, such as by scanning a rewards card or entering other identification information if the customer 38 has a shopping history with the store. In some embodiments, the data reading system 10 may prompt the customer 38 for additional information, such as by allowing the customer to initiate a search for additional items or by asking whether the customer 38 found every item they were looking for while shopping at the store. Such a prompt may be initiated by the data reading system 10, a connected POS system (e.g., POS system 160 of FIG. 2), and/or a remote service (e.g., remote server 158 of FIG. 2).

At step 206, the data reading system 10 determines whether there is an opportunity for up-selling or cross-selling add-on items 304 based on some or all of the following: (a) information relating to the processed items 20; (b) information input by the customer 38 during the transaction; (c) information associated with the identity of the customer 38 (such as purchase history information or other customer specific information); (d) other transaction information obtained by the data reading system 10 during the transaction; (e) information relating to the retail establishment (such as current sales, promotional items, seasonal items, etc.); and (f) commonly purchased items (such as milk or cereal) that are not included with the transaction. Some of these add-on items may be in stock, while others may not currently be in stock at the retail locations. Such items may, however, be available at a different location such as a warehouse or other related retail location.

In one embodiment, with reference to category (a) above, the determination at step 206 may evaluate whether one or more items that may correspond with one or more of the scanned items 20 is missing from the transaction. For example, if an electronic device appears on the customer's transaction list, then the data reading system 10 may identify batteries, a memory device, a protective cover, or other suitable related products that the customer 38 may also wish to purchase since these potential add-on items 304 are useful in conjunction with the electronic device. The data reading system 10 may obtain information for corresponding add-on items 304 in any suitable manner. For example, in some embodiments, corresponding add-on items 304 may be correlated in an inventory database 312 (see FIG. 4) that is in communication with the data reading system 10, where the database 312 stores information for all products offered for sale by a retail establishment and identifies corresponding add-on items 304 for each product. Product correlation may be based on any suitable factors, such as products that customers typically purchase together (e.g., cookies and milk, cheese, crackers, and wine), or products with interdependent functionalities (e.g., cameras and lenses, pencils and erasers, printers and toner), or using other suitable criteria. During the transaction, once the item 20 is processed, the data reading system 10 queries the inventory database 312 and receives information for the corresponding products that may be suitable add-on items 304 to the customer 38.

Similarly, with reference to category (b) described above, the data reading system 10 may recommend add-on items 304 based on the direct input provided by the customer 38. For example, if the customer 38 indicates that an item was not found, the data reading system 10 may query the inventory to determine whether the item is in stock (and the user did not know where to locate it). If the item is not in stock, the data reading system 10 may recommend other items that may be in stock, or other replacement items that may serve the same function as the missing item. For items in category (c), the data reading system 10 may also analyze the customer's prior purchase history information in determining whether to recommend add-on items 304 and which add-on items 304 are recommended. For example, the data reading system 10 may determine that customer 38 purchases eggs and milk every two weeks from the store, items missing from the current transaction. Accordingly, the data reading system 10 may determine that eggs and milk represent an up-selling or cross-selling opportunity and present those as add-on items 304.

With reference to category (d), the data reading system 10 may consider other transaction information in determining whether to suggest add-on items 304, such as suggesting add-on items 304 that may complete a common recipe based on the identity of the purchased items 20, or items on sale that may be of interest to the customer 38, or other suitable information.

With reference to category (e), the data reading system 10 may consider information relating to the retail establishment in determining whether to suggest add-on items 304, such as suggesting sale items with a reduced price for the current day, promotional items that the retailer wants to promote, seasonal items such as holiday goods or treats, or items related to an upcoming event (e.g., fireworks for Independence Day, chips or soda for an upcoming football game, etc.). With reference to category (f), the data reading system 10 may consider information relating to commonly purchased items the retail establishment in determining whether to suggest add-on items 304. Such items may be of general interest to most customers as opposed to customer-specific items.

At step 208, the data reading system 10 presents to the customer 38 the suggested add-on items 304 identified as potential up-selling or cross-selling opportunities based on the analysis of step 206. The add-on items 304 may be presented via the display 54 along with other suitable information, such as the name of the item, an image of the item, a price for the item, and the available size/count associated with the item. In some embodiments, the display 54 may also notify the customer 38 whether the add-on item 304 is available in store, available online for delivery, or both, and may also provide wait times for delivery of in-store items and projected delivery dates for home-delivered items. Data related to the available inventory for the in-store items may be retrieved by the data reading system 10 from a remote service (e.g., store server) coupled to the data reading system 10 that manages the real-time inventory for the retail store. Data related to the available inventory for potential home-delivered items may be retrieved by the data reading system 10 from a remote service (e.g., cloud server) coupled to the data reading system 10 that manages the real-time inventory for a plurality of retail stores. Such remote inventory may be located in a remote warehouse or another retail location that can fulfill such an order.

At this point, a determination at decision 210 is made by the customer 38 whether there is interest in purchasing one or more of the add-on items 304. If the customer 38 determines not to purchase any of the suggested add-on items 304, decision 210 branches to “NO” branch 212, which bypasses additional product purchasing steps of the method 200. The customer 38 rejects all add-on items 304 by selecting the appropriate icon on the screen 54 or otherwise providing input to the data reading system 10. Upon receiving the user input, at step 214, the data reading system 10 updates the transaction list and presents a payment screen for receiving payment information from the customer 38 for completing the transaction.

On the other hand, if the customer 38 would like to add one or more of the add-on items 304 to the transaction, decision 210 branches to “YES” branch 216, which leads to another decision 218 relating to a delivery option for the add-on item 304. As illustrated in FIG. 3, decision 218 may provide two options for delivering the add-on items 304 added to the transaction. A first option is for in-store delivery that enables the user to receive the item at the retail location during the present visit if the item is currently available at the retail location. A second option is for home delivery that enables the customer 38 to receive the item at the retail location later via home delivery after the present visit. This option may be available if the item is currently available at a remote location, which may provide for additional sales on items currently not in stock locally. In some embodiments, this option may be available even if the item is locally in stock in case the customer 38 would prefer not to wait for immediate fulfillment but would prefer to have it delivered. Fulfillment (e.g., home delivery) may be performed from either the local or the remote inventory as desired by the retailer.

In some embodiments, the data reading system 10 may present the add-on items 304 to the customer 38 and information relating to expected delivery times both for in-store delivery and/or home delivery for each add-on item 304 depending on which options is available for this transaction. If the customer 38 opts for home delivery for the suggested add-on items 304, decision 218 branches to “HOME DELIVERY” branch 220. The customer 38 may select home delivery for items that are not currently in stock but are otherwise available online for later delivery, or in instances when the customer 38 does not have time or the desire to wait for in-store delivery. At step 222, the data reading system 10 obtains delivery information (e.g., name and mailing address) for the customer 38 for delivering the add-on items 304. The data reading system 10 may receive the information directly from the customer 38 via the screen 54 or may retrieve address information from the loyalty account information associated with the customer 38 to expedite the transaction. In some embodiments, after obtaining the delivery information, the data reading system 10 may display the information and request confirmation by the customer 38. Thereafter, at step 224, the data reading system 10 updates the transaction list with the add-on items 304. At step 226, the data reading system 10 presents a payment screen for receiving payment information from the customer 38 for completing the transaction. Thus, the data reading system 10 of the self-checkout station is configured to complete a single transaction that includes both customer scanned items as well as items (e.g., add-on items 304) for home delivery. The data for the add-on items 304 to be delivered may be transmitted from the data reading system 10 (e.g., via the bi-optic or other scanner, or via the POS system, or via the in-store server) to the remote service that will be tasked with managing the fulfillment of home delivery. Delivery information may be generated in real-time during the transaction and may be returned to the data reader 10. In some embodiments, the data reading system 10 may print a transaction receipt detailing the items 20 purchased in the transaction along with identification of the add-on items 304 for delivery. The receipt may include tracking information, projected delivery date, and/or other delivery information for the customer's reference relating to the add-on items 304.

Returning to decision branch 218, if the customer 38 instead opts for in-store delivery for the suggested add-on items 304, decision 218 branches to “IN-STORE DELIVERY” branch 228. At step 230, the data reading system 10 obtains product information (e.g., name, SKU number, price, and location of the product in-store) from the inventory database 312 for each of the add-on items 304 and sends a request to a store employee 306 (see FIG. 4) to retrieve the add-on items 304. The request to the store employee 306 may be sent in any suitable fashion, such as a message via an electronic device viewable by the store employee 306, where the message includes the product information obtained from the inventory database 312 to facilitate the retrieval process.

In some embodiments, at step 232, the data reading system 10 may obtain the name and/or an image of the customer 38 for identification purposes and to help facilitate the in-store delivery process. In some embodiments, the image of the customer 38 may be obtained in real-time via the camera 56 of the data reading system 10. In other embodiments, the name and image of the customer 38 may be obtained from the customer's loyalty account information. For any age-restricted add-on items 304 (or other items 20 purchased in the transaction) such as alcohol, the data reading system 10 may compare the image obtained via the camera 56 with an image of the customer 38 from a loyalty account to authenticate the user and authorize the purchase. The customer's loyalty account may have previously been pre-authorized for purchase of such age-restricted items based on a verified birthdate or other inspection of an identifier (e.g., driver's license). This pre-authorization may be performed by store personnel to verify the appropriate age for such age-restricted items, with such pre-authorization being linked to the customer's loyalty account or other account so that authorization for the transaction to still be completed in a frictionless manner without store personnel intervention while also complying with any applicable laws that may allow for such pre-authorization. In some embodiments, age-restricted items may trigger an alert to an assisting store personnel (e.g., self-checkout attendant or the store employee 306 fulfilling the request) to verify and authorize purchase of such items.

Once the name and/or image are obtained, the request may be sent along with the product information (described at step 230) so the store employee 306 can identify the customer 38 for in-store delivery. Additional details of an example delivery management system 300 are provided below with reference to FIG. 4. Returning to FIG. 3, after the data reading system 10 sends the request to the store employee 306, the add-on items 304 are added to the transaction list and the transaction is completed in a similar fashion as described with respect to steps 224, 226. The completion of the transaction may be performed before delivery of the add-on item(s) 304 by the store employee 306 without suspending the transaction, which may free up the data reading system 10 and the self-checkout station for the next customer without needing to wait for the in-store delivery to occur

FIG. 4 is a schematic diagram illustrating a delivery management system 300 for in-store product delivery of add-on items 304 based on a request by the customer 38 as described above. FIG. 4 illustrates an example layout for a retail facility 302 in accordance with embodiments of the disclosure. With reference to FIG. 4, the retail facility 302 includes one or more data reading systems 10 available for use by the customer 38 (e.g., at self-checkout systems, smart shopping carts, etc.) to process a transaction for purchasing available items. As described previously with reference to FIG. 1, the data reading system 10 is operable to identify add-on items 304 for purchase based on one or more pieces of information, including: the customer's transaction list, information input by the customer, information in a customer loyalty account, and/or other suitable information. As described in method 200, when the customer 38 identifies desired add-on items 304 to add to the transaction based on the suggestions presented by the data reading system 10, the customer 38 pays for the add-on items 304 (along with the scanned items 20) at the data reading system 10 and then awaits in-store delivery of the add-on items 304 (assuming the in-store delivery option was selected from the decision 218). The data reading system 10, in turn, provides the store employee 306 with product information for the add-on items 304 and an image of the customer 38 to facilitate the delivery process as noted previously in method 200. With reference to FIG. 4, the retail facility 302 may include one or more designated delivery areas 308 offset from a location of the data reading systems 10 to facilitate delivery for the store employee 306 and to ensure that the data reading system 10 is available for use by others while the customer 38 awaits delivery of the add-on items 304 in a separate location.

In an example operation of the delivery management system 300, the data reading system 10 communicates product information to the store employee 306 (e.g., via a mobile device or other computing device associated with the employee) identifying the add-on items 304 and their respective location on the shelves 310 of the retail facility 302. Upon receiving the information, the store employee 306 finds and retrieves the add-on items 304 from the shelves 310. Meanwhile, upon completing the transaction at the data reading system 10, the customer 38 moves away from the data reading system 10 toward the designated delivery area 308, which may be near a store exit, customer service area, or other convenient location to facilitate such delivery, to await delivery of the add-on items 304. In some embodiments, the designated delivery area 308 may be separated into individually labeled delivery spaces to streamline and expedite the delivery process. In such embodiments, the data reading system 10 assigns a particular delivery space (e.g., space D) to the customer 38 within the designated delivery area 308 to facilitate the delivery process. The information to the customer 38 may be communicated via the monitor 54 during the checkout process, and may be communicated to the store employee 306 when receiving the product information and the image of the customer 38.

Upon completion of the item retrieval process, the store employee 306 reviews the image of the customer 38 and the information relating to the delivery space where the customer 38 is waiting. The store employee 306 then finds the customer 38 in the designated delivery area 308, compares the image of the customer 38 to the person accepting delivery to ensure the add-on items 304 are properly delivered, and then completes the delivery. Having received delivery of the add-on items 304, the customer 38 may now leave the retail facility 302 with all items in hand. The store employee 306 may thereafter log the completed delivery in the data reading system 10 to complete the transaction.

For embodiments involving a smart shopping cart where the transaction list is updated as the items 20 are inserted into the cart, upsell offers and in-store delivery may occur while the customer 38 is still shopping. In such embodiments, the location of the smart shopping cart may be tracked by an in-store geolocation system and presented to the store employee 306 via the employee's electronic device. Upon receiving the request for in-store delivery of the add-on items 304, the employee's electronic device may display the request as well as the location within the retail facility 302 of the smart shopping cart (and/or the customer's smart phone or other mobile device that may also be provided in some embodiments).

As such, the employee 306 may find the customer 38 wherever the customer 38 is located with the shopping cart to deliver the add-on item 304. The customer's name and/or photo with the request may be additionally helpful to quickly identify and verify the appropriate customer 38. Upon the in-store delivery, the add-on item 304 may be verified as the correct item when placed into the cart and compared to the current transaction list so as to not double count the add-on item 304 when placing the add-on item 304 into the cart. The request may remain active in the queue presented by the employee's electronic device until cleared as being completed. In some embodiments, the employee 306 may manually clear the request by selecting an input indicating that such in-store delivery of the add-on items 304 is complete, or by scanning the add-on items 304 with the employee's electronic device when the delivery occurs. In some embodiments, clearing the request may automatically be completed responsive to the add-on items 304 being placed in the customer's smart shopping cart, which initiates a delivery complete message to the employee's electronic device (e.g., via the network and/or directly via a short-range communication) to clear the request from the queue as being fulfilled.

The smart shopping cart may include an integrated electronic display and/or be connected to a device (e.g., mobile device) having an electronic display for presenting a user interface for the customer 38 to interact with. Through such a user interface, the customer 38 can accept upsell offers, which are added to the transaction and can be fulfilled as described above—including by in store delivery or by home delivery similar to the self-checkout station embodiment described above, but through the user interface associated with the smart shopping cart. In some embodiments, the user interface on the shopping cart may present a store map or otherwise provide guidance to the customer 38 to find the upsell item within the store as opposed to sending the request to one or more employees to fulfill the request.

In the embodiment of FIG. 4, the inventory database 312 is illustrated as a standalone system separate from the data reading system 10. In other embodiments, the inventory database 312 may instead be integrated with the data reading system 10 in other embodiments such that the data reading system 10 is operable to manage the analysis steps described in method 200 for up-selling and cross-selling the add-on items 304, confirming product available either in-store or online for later delivery, obtaining customer information, and coordinately in-store or home delivery efforts.

It should be understood that in other embodiments, certain steps described in method 200 of FIG. 3 and with reference to the delivery management system 300 in FIG. 4 may be combined, altered, varied, and/or omitted without departing from the principles of the disclosed subject matter. It is intended that subject matter disclosed in portion herein can be combined with the subject matter of one or more of other portions herein as long as such combinations are not mutually exclusive or inoperable. In addition, many variations, enhancements and modifications of the systems and methods described herein are possible.

The terms and descriptions used above are set forth by way of illustration only and are not meant as limitations. Those skilled in the art will recognize that many variations can be made to the details of the above-described embodiments without departing from the underlying principles of the invention.

1. A data reading system comprising:
a housing supporting a scan window;
one or more data readers disposed within the housing, the one or more data readers having a field-of-view directed through the scan window, wherein the or more data readers are operable to capture encoded data from one or more items as each item passes across the scan window;
a processor operable to receive the encoded data from the data reader and obtain item information for each item from the one or more items, the processor generating a transaction list including the one or more items; and
a display operable to display the item information for each of the one or more items, wherein the processor is further operable to:
identify one or more add-on items based on the item information obtained from the encoded data for the one or more items;
present add-on item information on the display for each of the one or more identified add-on items;
provide a prompt on the display seeking input from a customer for each of the one or more add-on items, wherein the prompt includes an option for selecting in-store delivery or home delivery for the one or more add-on items;
determine one or more selected add-on items from the one or more add-on items based on the customer input in response to the prompt;
update the transaction list to include the one or more selected add-on items and complete the transaction including scanned items and the one or more selected add-on items; and
coordinate delivery of the add-on items to the customer based on the selected option in the prompt for in-store delivery or home delivery.

2. The data reading system of claim 1, wherein the processor is further operable to:
provide a prompt on the display seeking customer input about additional available items different from the one or more items in the transaction list;
present the additional available items on the display along with an option for selecting in-store delivery or home delivery for the additional available items; and
coordinate delivery of the additional available items to the customer based on the selected option for in-store delivery or home delivery.

3. The data reading system of claim 2, wherein the processor is further operable to identify one or more add-on items based on the customer input about additional available items.

4. The data reading system of claim 1, wherein in response to selection of the home delivery option, the processor is further operable to retrieve a home delivery address based on a loyalty account associated with the customer to initiate a request for home delivery of the add-on items.

5. The data reading system of claim 1, wherein the prompt on the display for selecting in-store delivery or home delivery further includes an estimate wait time for in-store delivery and an estimate delivery time for home delivery.

6. The data reading system of claim 1, wherein the processor is further configured to process a payment for the one or more items and the one or more selected add-on items on the transaction list prior to coordinating delivery of the add-on items.

7. The data reading system of claim 1, further comprising a camera operable to obtain an image of the customer, wherein in response to selection of the in-store delivery option, the processor is further operable to transmit a message to an electronic device that corresponds to a store employee, the electronic message including a request to retrieve the one or more selected add-on items and the image of the customer associated with the one or more selected add-on items.

8. The data reading system of claim 1, wherein in response to selection of the in-store delivery option, the processor is further configured to assign an in-store designated delivery area and communicate the in-store designated delivery area to the customer, and wherein the processor is further operable to transmit a message to an electronic device that corresponds to a store employee, the electronic message including a request to retrieve the one or more selected add-on items and the in-store designated delivery area associated with the customer for in-store delivery.

9. The data reading system of claim 1, further comprising an inventory database including item information for a plurality of available items, wherein the processor is further operable to query the inventory database based on the item information obtained from the encoded data for the one or more items and identify the one or more add-on items from the plurality of available items.

10. The data reading system of claim 1, further comprising an inventory database storing purchase history information for the customer, wherein the processor is further operable to query the inventory database and identify the one or more add-on items based on the purchase history information associated with the customer.

11. The data reading system of claim 1, wherein the housing, one or more data readers, processor, and display are all integrated in a standalone system.

12. A method of data reading at a self-checkout station, the method comprising:
capturing, via one or more data readers, encoded data from one or more items during a checkout transaction;
decoding, via a processor, the encoded data to obtain item information for each item from the one or more items based on the encoded data;
querying, via the processor, an inventory database to identify one or more add-on items based on the item information obtained from the encoded data for the one or more items;
presenting, via a display, add-on item information for each of the one or more identified add-on items for review by a customer;
receiving, via the processor, instructions from the customer for each of the one or more add-on items, wherein the instructions include a selection for in-store delivery or home delivery for the one or more add-on items;
determining, via the processor, one or more selected add-on items from the one or more add-on items based on the instructions from the customer;
processing, via the processor, payment for the one or more items and the one or more selected add-on items; and
coordinating, via the processor delivery of the add-on items to the customer based on the selection of in-store delivery or home delivery.

13. The method of claim 12, further comprising:
receiving, via the processor, input from the customer regarding a search for additional available items different from the one or more items;
querying, via the processor, the inventory database to determine an inventory status for the additional available items;
presenting, via the display, a prompt for the customer including a selection for in-store delivery or home delivery based on the inventory status of the additional available items; and
coordinating, via the display, delivery of the additional available items to the customer based on the selection for in-store delivery or home delivery.

14. The method of claim 13, wherein the step of querying, via the processor, the inventory database to identify one or more add-on items is further based on the search for additional available items.

15. The method of claim 12, wherein in response to receiving instructions for home delivery of the selected add-on items, the method further comprises retrieving, via the processor, a home delivery address based on a loyalty account associated with the customer to coordinate delivery of the add-on items.

16. The method of claim 12, wherein in response to receiving instructions for home delivery of the selected add-on items and processing the payment, the method further comprises initiating, via the processor, delivery for the add-on items, and printing a receipt, via a printer of the self-checkout station, that includes delivery information related to delivery of the add-on items.

17. The method of claim 12, further comprising:
obtaining, via a camera, an image of the customer during the checkout transaction in response to selection for in-store delivery for add-on items;
transmitting, via the processor, a message to an electronic device that corresponds to a store employee, the electronic message including a request to retrieve the one or more selected add-on items and the image of the customer associated with the one or more selected add-on items.

18. The method of claim 12, further comprising:
tracking a location of a smart shopping cart functioning as the self-checkout station for the customer to scan items while placing the items into the smart shopping cart;
sending a request for in-store delivery of the add-on items to an electronic device of a store employee;
displaying the request and the location of the smart shopping cart for delivery of the add-on items to the customer; and
clearing the request from a request queue associated with the store employee in response to the in-store delivery being completed.

19. The method of claim 12, further comprising comparing, via the processor, the image of the customer to a corresponding image in a loyalty account associated with the customer to ensure the images match to authenticate a user to verify pre-authorized age information for approving delivery of age-restricted add-on items.

20. The method of claim 12, further comprising:
querying, via the processor, the inventory database to obtain purchase history information associated with the customer, the purchase history information identifying previously purchased items;
comparing, via the processor, the one or more items to the previously purchased items based on the purchase history information to identify missing items from the checkout transaction; and
identifying, via the processor, one or more add-on items based on the missing items.
